(19) United States
(12) Patent Application Publication
(10) Pub. No.: US 2026/0129694 A1
(43) Pub. Date: May 7, 2026

(54) USING AN APPLICATION IDENTIFIER TO IDENTIFY AN APPLICATION INSTANCE RUNNING ON A WTRU AND PROVIDE SPECIAL QOS TREATMENT PER APPLICATION INSTANCE

(71) Applicant: InterDigital Patent Holdings, Inc., Wilmington, DE (US)

(72) Inventors: Debashish Purkayastha, Eagleville, PA (US); Michael Starsinic, Newtown, PA (US); Anuj Sethi, Ottawa (CA); Samir Ferdi, Kirkland (CA)

(73) Assignee: InterDigital Patent Holdings, Inc., Wilmington, DE (US)

(21) Appl. No.: 18/939,974

(22) Filed: Nov. 7, 2024

(51) Int. Cl. H04W 76/11; H04W 28/02

(52) U.S. Cl. CPC H04W 76/11; H04W 28/0268

(57) ABSTRACT

Systems, methods, devices, and instrumentalities are described herein related to using an application identifier to identify an application instance running on a WTRU and providing special QoS treatment per application instance. A device (e.g., an enabler server) may include a processor configured to perform one or more actions. The device may receive a first message. The first message may include an application instance identifier and state information. The device may send, to a first network node, a second message. The second message may include the application instance identifier and the state information. The device may receive, from a second network node, a third message. The third message may include the application instance identifier and a change of state request notification. The device may receive a change of state notification. The device may send, to the second network node, a fourth message.

### BACKGROUND

Mobile communications using wireless communication continue to evolve. A fifth generation may be referred to as 5G. A previous (legacy) generation of mobile communication for example, may be fourth generation (4G) long term evolution (LTE).

### SUMMARY

Systems, methods, devices, and instrumentalities are described herein related to using an application identifier to identify an application instance running on a WTRU and providing special quality of service (QoS) treatment per application instance. A device (e.g., an enabler server) may include a processor configured to perform one or more actions. The device may receive a first message. The first message may include an application instance identifier and state information. The device may send, to a first network node, a second message. The second message may include the application instance identifier and the state information. The device may receive, from a second network node, a third message. The third message may include the application instance identifier and a change of state request notification. The device may receive a change of state notification. The device may send, to the second network node, a fourth message.

In examples, the second message may be a Non Access Stratum (NAS) mobility management (NAS-MM) or an NAS session management (NAS-SM) message. The state information may indicate whether the application is active or inactive. The third message may be a packet data unit (PDU) session modification message. The third message may indicate that the application instance identifier is authorized to be associated with the WTRU. The third message may include QoS rules for a flow associated with the traffic of the application. The fourth message may be a NAS-SM message. The WTRU may be a mobile termination (MT) part of the WTRU, and the change of state notification may be received from a terminal equipment (TE) part of the WTRU. The first message may be received from a hosted application in the TE part of the WTRU.

A device (e.g., an enabler server) may include a processor configured to perform one or more actions. The device may receive a first message. The first message may include an application instance identifier, an indication associated with a state of an application, and a notification that the application instance identifier is associated with a PDU session. The device may send, to a second network node, a second message. The second message may include a request to associate the application instance identifier with the PDU session. The second message may include the indication associated with the state of the application. The device may receive, from a third network node, an indication of whether the application instance identifier is authorized to be associated with the PDU session. The device may receive, from the third network node, updated policy and charging control (PCC) rules. The updated PCC rules may be based on the application instance identifier. The device may send, to a wireless transmit/receive unit (WTRU), a third message. The third message may include the application instance identifier and a change of state request notification. The device may receive, from the WTRU, a fourth message. The fourth message may notify the first network node of a change of state of the application. The fourth message may include traffic associated with the application.

In examples, the second message may include an identity of the third network node that services the PDU session. The third message may be a PDU session modification message. The third message may indicate that the application instance identifier is authorized to be associated with the WTRU. The third message may include QoS rules for a flow associated with the traffic of the application. The fourth message may be a NAS-SM message. The device may update a QoS configuration of the PDU session based on the fourth message.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example deployment of WTRU-x.

FIG. 3 is a diagram illustrating a WTRU provided application identification (ID) and application state information.

### DETAILED DESCRIPTION

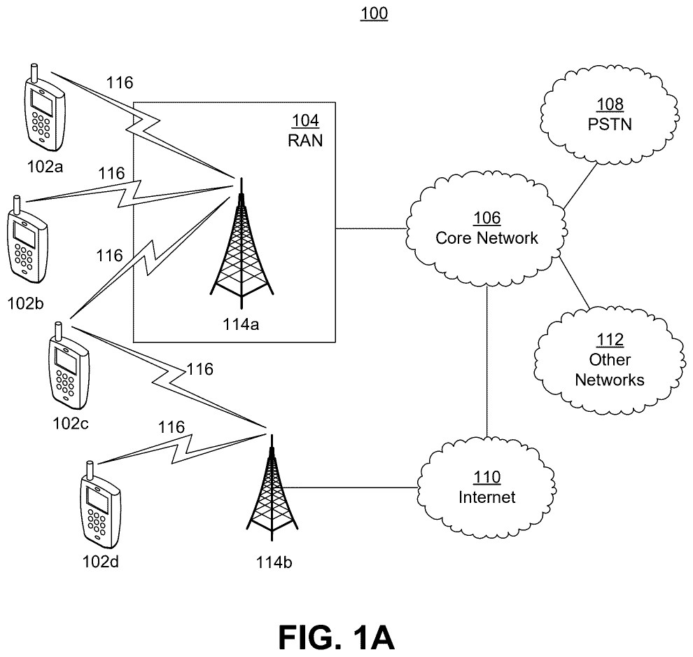

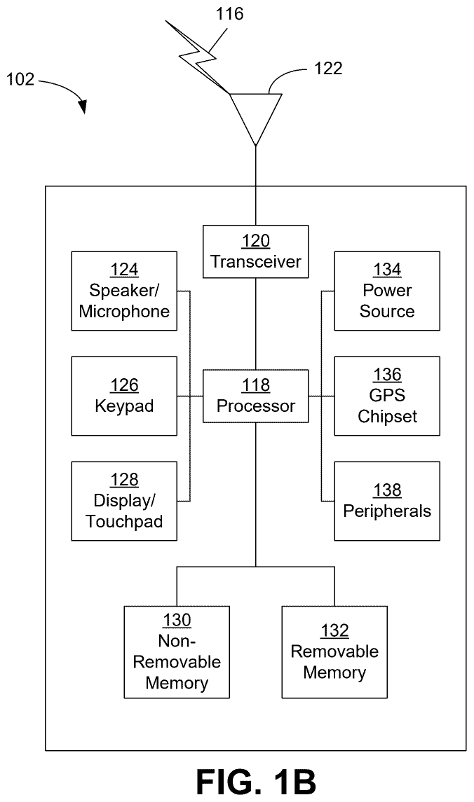

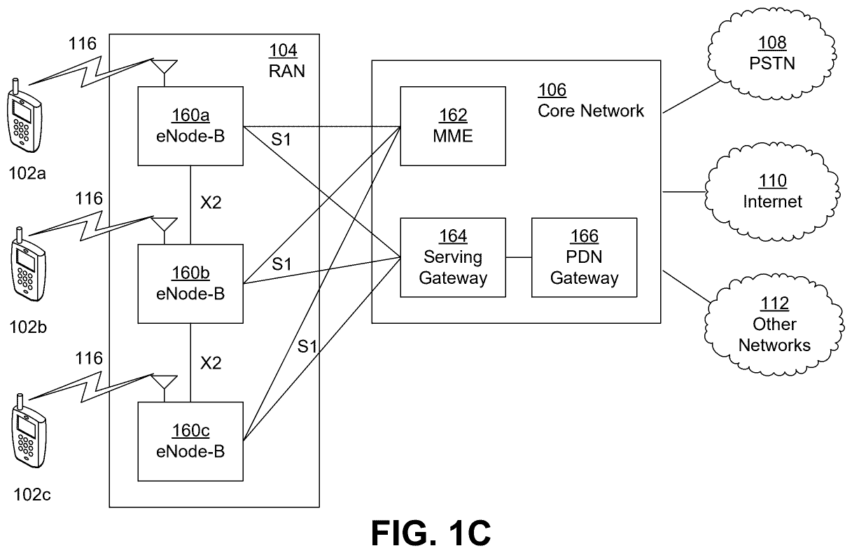

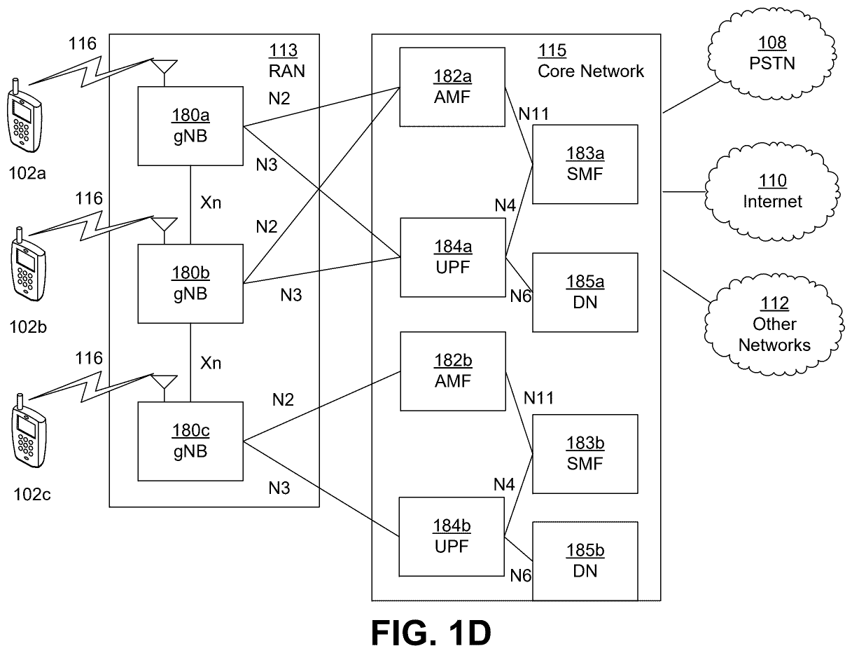

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station and/or a STA, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUS 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an ad-hoc mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be testing equipment. Direct RF coupling and/or wireless communications via RF circuitry (e.g., which may include one or more antennas) may be used by the emulation devices to transmit and/or receive data.

Reference to a timer herein may refer to a time, a time period, a tracking of time, a tracking of a period of time, a combination thereof, and/or the like. Reference to a timer expiration herein may refer to determining that the time has occurred or that the period of time has expired.

The terms application and/or application instance(s) may be used interchangeably in this paper. An application instance may refer to an occurrence of an application running on a WTRU.

A first example may include two WTRUs to host the same gaming application. The users of the two WTRUs may be playing a game against each other. In this example, the application that is running in the first WTRU may be a first application instance and/or the application that is running in the second WTRU may be a second application instance.

A second example may include a WTRU that is used to route traffic to and/or from the network for two (e.g., separate) gaming systems that are running the same type of game. In this example, the application that is running on the first gaming system may be a first application instance, and the application that is running on the second gaming system may be a second application instance. The two application instances may carry the same type of traffic, may be associated with the same WTRU, and/or may be entitled to different traffic treatment by the network. For example, the first application instance may be inactive, while the second application instance may be active.

A subscription permanent identifier (SUPI) and an external identifier may be examples of subscription identifiers. An international mobile subscriber identity (IMSI) may be an example of a SUPI.

A packet data unit (PDU) session may be a session between a WTRU and a PDU session anchor (PSA) user plane function (UPF). The PDU session may be used to send PDUs from a WTRU to a DN and/or from a DN to a WTRU. The PDUs may be IP packets, Ethernet frames, and/or opaque packets. The PDUs may be associated with a quality of service (QoS) flow of the PDU session. A PDU session may be associated with one or more QoS flows.

A PSA UPF may be a type of user plane anchor.

PDU session modification request may be an example of a non-access stratum of a session management (NAS-SM) message that may be sent from the WTRU to the 5GS network function (e.g., session management function (SMF)).

PDU session modification command may be an example of a NAS-SM message that may be sent to the WTRU by the 5GS network function (SMF).

WTRU actions may be provided.

The mobile termination (MT) part of the WTRU may receive an application instance identifier and/or state information from a WTRU hosted application.

The MT part of the WTRU may send a message to the network. The message may include the application instance identifier and/or state information.

The message may be a NAS-MM or a NAS-SM message.

The state information may indicate if the application is active or inactive.

The MT part of the WTRU may receive a PDU session modification message that includes the application instance identifier and an indication that the SMF requests to be notified of changes of state of the associated application.

This message may serve as an indication that the application instance identifier is authorized to be associated with the WTRU.

The message may include QoS rules for a flow that carries the application's traffic.

The MT part of the WTRU may receive a notification that the application's state has changed and/or may send a NAS-SM message to an SMF that carries the application's traffic.

SMF actions may be provided.

The SMF may receive a notification that an application instance identifier is associated with a PDU session. The notification may include the application instance identifier and/or an indication of the application's state.

The SMF may send a message to a unified data management (UDM). The message may indicate a request to associate the application instance identifier with a PDU session. The message may indicate the application's state.

The message may indicate the identity of the policy control function (PCF) that serves the PDU session.

The SMF may receive an indication of whether the application identifier is authorized to be associated with the PDU session.

The SMF may receive updated policy and charging control (PCC) rules from a PCF. The PCC rules may be based on the application identifier.

The SMF may send a PDU session modification message that includes the application instance identifier and/or an indication that the SMF requests to be notified of changes of state of the associated application.

This message may serve as an indication that the application instance identifier is authorized to be associated with the WTRU.

The message may include QoS rules for a flow that carries the application's traffic.

The SMF may receive a NAS-SM message to an SMF that carries the application's traffic. This message may trigger the SMF to update the QoS Configuration of the PDU session.

Session management may be provided in 5G, for example. Synchronization of PDU session State(s) may be provided.

The WTRU and/or network may (e.g., independently) maintain state information for a WTRU's PDU session. If a PDU session is released, the PDU session may be considered to be in the PDU SESSION INACTIVE state, for example.

The WTRU may send a PDU session Status IE to the AMF. The PDU session Status IE may be sent to the AMF in a NAS-MM message. The PDU session Status IE may be used by the WTRU to indicate to the network that the WTRU considers certain PDU sessions to be in the PDU SESSION INACTIVE state. If the AMF receives an indication that a WTRU considers a PDU session to be in the PDU SESSION INACTIVE state and/or the AMF does not yet consider the PDU session to be in the PDU SESSION INACTIVE state, the AMF may be triggered to perform a local release of the PDU session. The AMF may consider (e.g., begin to consider) the PDU session to be in the PDU SESSION INACTIVE state.

The WTRU may send a PDU session Modification request to the network to request specific QoS handling for selected service data flow(s) (SDF(s)). The SDF(s) may be described as packet filter(s). The WTRU may be able to request that the SDF(s) be segregated into a dedicated QoS flow which is separate from other QoS flows even if an existing QoS flow may support the requested QoS.

In examples, an application instance state may be provided. One or more application clients may be installed in a WTRU. The application clients may be activated (e.g., triggered to transition from inactive to running) by a user. Some application clients may be running autonomously if the WTRU is powered on. Some application clients may pause or reduce activity. These may (e.g., still) be active applications but in a paused or low activity state. If the application clients are in a reduced activity state, the network may provision network resources and/or assign QoS to a lower level, for example, until these application clients return to a fully active state.

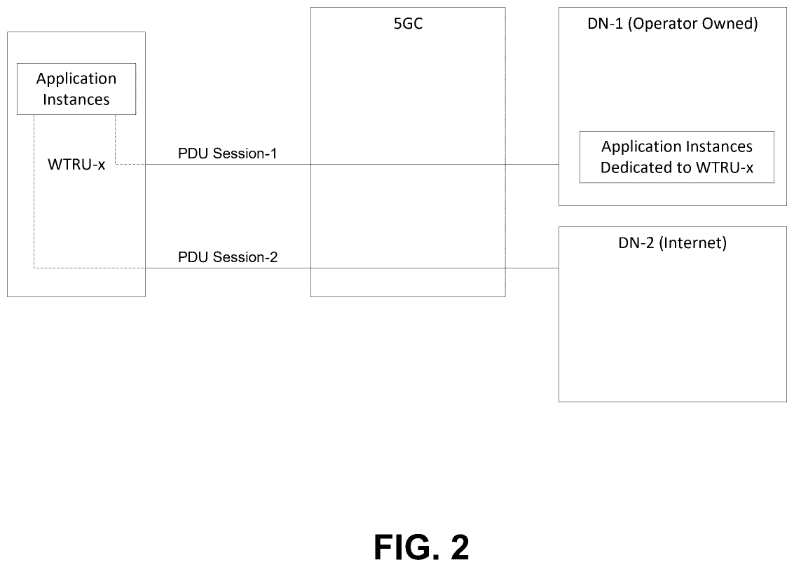

In examples, a WTRU application client instance may interact with more than one application server in the DN. A WTRU (e.g., WTRU-x in example deployment of FIG. 2) may include an MT part and a TE part. The TE part may include a user interface that presents a screen, mouse, and/or keyboard to the user. The MT part may be used to interface to a cellular network such as the network (e.g., 5G network). The WTRU may use its connection to the network (e.g., 5G network) to connect to a first data network (e.g., DN-1 in FIG. 2). DN-1 may host computing resources that may be controlled by a mobile network operator. The computing and/or storage resources may run application instances that are associated with the subscriber of WTRU-x. An advantage of this architecture may be that the WTRU (e.g., specifically the TE part of the WTRU) may not need to host as much computing and/or storage resources in order to run applications for the user of the WTRU. The applications may run in DN-1 and/or the user may interface with the applications via the WTRU(s) connected to the DN-1 (e.g., PDU session-1). The WTRU may use other PDU sessions to connect to other data networks. For example, in FIG. 2, PDU session-2 may be used to connect to the internet. The internet may be considered a data network.

FIG. 2 illustrates an example deployment of the WTRU to network connection.

In the example deployment of FIG. 2, a WTRU may have many (e.g., in excess of 100) applications that run in DN-1. At any given time, (e.g., most of) the applications may be expected to have relatively little activity because the user is currently utilizing the applications.

The network may configure QoS rules, QoS Profiles, and/or N4 rules for the traffic of an (e.g., each) application instance(s) running in the WTRU. There may be one or more application instances running in the WTRU. The assigned QoS rules and/or QoS profiles for an application may remain the same through the lifetime of the application. The lifetime of the application instance may refer to the time that the application instance is running, regardless of the state of the application instance (e.g. active, reduced activity, inactive, etc.). The requested (e.g., required) QoS treatment for an application client may change if the application instance moves to a reduced activity state. The network (e.g., 5G network) may not identify an application client or identify if an application is in a reduced activity state. The network (e.g., 5G network) may not be able to take action to modify QoS rules and/or modify the amount of network resources that are allocated for the application's traffic.

This paper may address how the network may identify an application instance in a WTRU, know its current state, and/or modify the QoS configuration of the identified application instance.

An application identity is an identifier, which may identify an application instance. application instances may be provisioned with the identity by an application function (AF) (e.g., service provider) at the application level.

An application profile is information that may be stored in the UDM and/or unified data repository (UDR). The information may include an application identity, which may identify an application instance in a WTRU and/or may help in identifying the profile. The information may include information about QoS treatment that is requested (e.g., required) by the application if the application is in different states, etc. The profile may be provisioned by an AF through the network exposure function (NEF). The application profile may be linked with a user subscription. Linked may refer to associating the application profile with a subscription. A subscription may be identified by a subscription identifier.

The TE part in the WTRU may provide the MT part of the WTRU with information about an application instance that runs in the TE. The information may include an application ID and/or information about the application's status (e.g., active or inactive). The MT part of the WTRU may send NAS-MM messages to provide the AMF and/or 5GC with information about the application (e.g., the state of the application). The AMF may trigger an application ID based authentication, verification, and/or policy update with other 5G network functions like the SMF, PCF, UDM, and/or UDR. Policies and/or rules may be updated based on the state of the application. The PDU session may be modified based on the updates policies and/or rules. In examples, the QoS Configuration of the PDU session may be modified so that the applications'traffic receives different QoS treatment based on the state of the application.

Enhancing the system (e.g., the 5G System) with the capability to identify application instances and/or setting QoS treatment for an (e.g., each) application instance may help to optimize how the network resources are utilized.

Application instance(s) and/or setting QoS per application may be identified. An application ID may be used to identify an application instance. The application ID and/or relevant policy information may be provisioned by an AF in the UDM and/or UDR. The WTRU may provide the application instance identifier and application state information to the network and the network may use the application ID to find out the associated PDU session ID and/or QoS flow ID. The policy for the application instance may be identified from the application profile based on the application ID. The policy may be related to QoS settings that are applied to the PDU session that carries the application's traffic. In examples, the policy may be used to configure the QoS flow that carries the application's traffic.

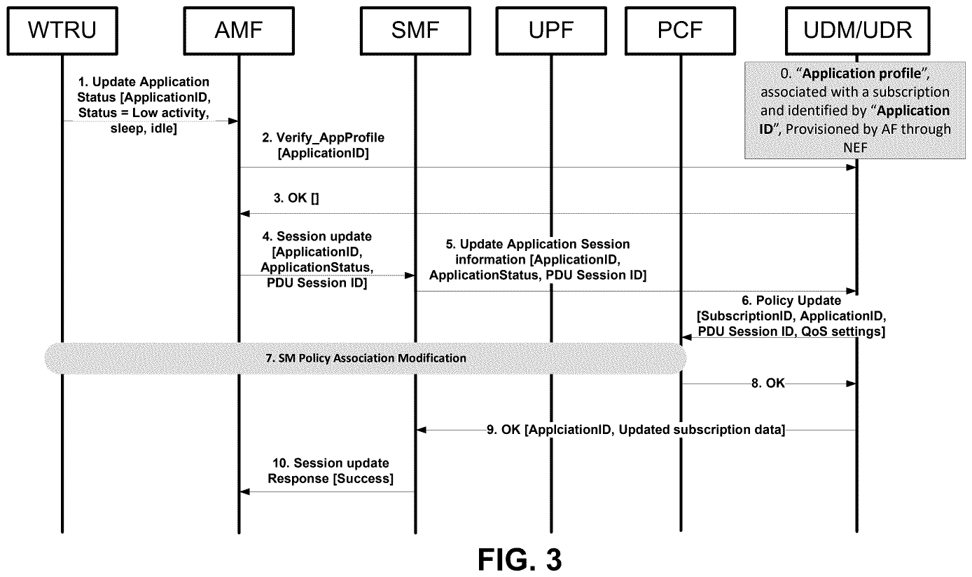

A WTRU may provide the network with information about an application instance. The information may include the application ID and/or the state change information. A WTRU initiated application specific QoS setting may be provided. FIG. 3 illustrates a WTRU provided application ID and application state information.

At 0, application instances running in a WTRU may be associated with an application profile. The application profile may be identified by an application ID. The application ID may be an identifier, may be a numeric or character string, built based on owner and/or service provider name and/or ID, application name, application type, etc.

The application profile may have information about QoS handling in different states of the application. The application profile may include information about the allowed DN the application may access and/or may be connected to. The profile may indicate if the application can connect to one or more DN and/or what QoS may be supported for a (e.g., each) DN the application is connected to. The application profile may have information about the PDU session IDs associated with the application instance.

The application profile may be associated with a valid subscription of the WTRU. The application profile may be provisioned by the AF in the UDM and/or UDR. The application client instances in the WTRU may be provisioned with an application ID associated with an application profile. The application client instances may be provisioned at the application level and may not be described in detail herein.

The application profile may be information that is stored in the UDR and/or accessible by other network functions via the UDM. The application profile may include the following information: an application instance identifier; a list of subscription identifier(s) that may use the associated application instance; a list of DNN/S-NSSAI combinations that may indicate what data networks and/or network slices the application is allowed to send and/or receive traffic through; for a (e.g., each) DNN/S-NSSAI combination, a QoS information for the application; and flow descriptions for the traffic of the application instance.

The QoS information may be a set of QoS parameters (e.g., QoS Requirements) for each state that the application instance may take. In examples, a first set of QoS parameters (e.g., QoS Requirements)for the application instance may indicate a packet delay budget, data rate, and/or minimum error rate that is requested (e.g., required) by the application if the application is in an active state. In examples, a second set of QoS parameters (e.g., QoS Requirements)for the application instance may indicate a packet delay budget, data rate, and/or minimum error rate that is requested (e.g., required) by the application if the application is in an inactive state A third state may be priority state, if the application is given priority over other applications.

An active state may refer to a state where the application is sending and/or receiving relatively large amounts of data. An inactive state may refer to a state where the application is sending and/or receiving relatively small amounts of data (e.g., keep alive messages, availability information, and/or presence information). Priority state may indicate to the network that the application traffic may be given (e.g., highest or higher) priority compared to other applications.

At 1, the MT part of the WTRU may inform the AMF about the change of state of an application instance identified by an application ID. The MT part may inform the AMF about an application state change by sending an update application status message. The update application status message may indicate that the application has changed state by including the application ID. The current state or state change may be indicated by the status information element. The status may indicate if the current state is in, for example, at least one the following modes: low activity, sleep, or idle. These example modes may be information about the state and/or may be interpreted by the application profile.

In an example, an application function may have provided the application instance identifier to an application that is running in the TE part of the WTRU. This may occur, for example, before 1. If the state of the application changes (e.g., changes to active or inactive), the application may send a notification to the MT part of the WTRU. The notification may include the application instance identifier and an indication of the current state of the application instance. The notification may trigger the MT part of the WTRU to send a NAS-MM message to the AMF. The NAS-MM message may include an application instance notification container. The application instance notification container may include the application instance identifier and/or an indication of the current state of the application instance.

At 2, the AMF may receive the NAS-MM message. The AMF may decide to verify if the application identified by the application ID is allowed to receive special QoS treatment (e.g., or other treatments, like priority handling, connect to a specific DN, etc.). The AMF may send a Verify AppProfile message, which may include an application ID, to the UDM and/or UDR. The message may indicate UDM to verify if the application identified by application ID is allowed to receive special QoS treatment.

The AMF may receive information from the UDM and/or UDR about a reporting configuration.

The AMF may configure the WTRU with a reporting period (e.g., allowed vs. not allowed), periodicity, for example, every few seconds. The WTRU may aggregate the state change and/or report at the agreed interval with the network. The network may (e.g., alternatively) configure the WTRU to use application and/or user plane based reporting of the application state changes (e.g., vs. control plane-based NAS signaling).

The NAS-MM that is received may include an application instance notification container. The AMF may (e.g., transparently) forward the container to the UDM to request that the UDM and/or UDR verify if the application instance is associated with the WTRU's subscription. The message at 2 may include the application instance notification container and/or the subscription identifier of the WTRU.

At 3, the UDM may verify the application ID is associated with a valid subscription of the WTRU. If it is associated with the valid WTRU subscription, the UDM may check the application profile to verify if the application is allowed to have special QoS treatment. If allowed, the UDM and/or UDR may respond with an approving (e.g., OK) message to indicate to the AMF that special QoS treatment may be provided to the application instance, identified by the application ID, in the WTRU. The approving (e.g., OK) message may further indicate which DNN/S-NSSAI combination the application is allowed to send traffic through.

At 4, the AMF may initiate special QoS treatment for the application instance in the WTRU. The AMF may use the DNN/S-NSSAI combinations that were received from the UDM and/or UDR to identify which PDU session(s) may be carrying traffic of the application. The AMF may determine to send a notification to a (e.g., each) SMF that serves a PDU session that may be carrying traffic of the application. 4 through 10 may be repeated for a (e.g., each) PDU session and/or SMF.

The AMF may indicate to the SMF that the PDU session is associated with the application instance, identified by application ID, by sending a session update message. The message may include: the application ID, which may identify the application instance and may be used to select the application profile in the UDM; and the application status, which may indicate the state of the application instance (e.g., sleep, idle, active, low-active, etc.).

The AMF may send the session update message based on an indication from the UDM and/or UDR that the content of the application instance notification container is valid for the WTRU's subscription. The session update message may include the application instance notification container.

At 5, the SMF may determine which UDM can be used to obtain the QoS parameters (e.g., requirements) for the application. The SMF may determine the UDM based on the application ID and/or subscription identifier of the WTRU. The SMF may send an update application session information request message to the UDM and/or UDR. The purpose of this request message may be to trigger a policy update of the PDU session based on the state of the application. The message may include: an application ID, which may identify the application instance, to be used to select the application profile in UDM; and/or an application status may indicate the state of the application instance (e.g., sleep, idle, active, low-active, etc.). The message may indicate a change in status from active to idle, active to sleep, etc., for example. The application state may be present in the application profile and/or may indicate the allowed QoS treatment for the application instance, and/or the identity of the PCF that is serving the PDU session.

At 6, the UDM and/or UDR may retrieve the application profile for the received application instance ID. The UDM may verify if the application is allowed to have differentiated QoS treatment in the DNN/S-NSSAI combination that is associated with the PDU session. If allowed, the UDM may determine what QoS treatment is allowed for the application based on the state information that was received from the SMF at 5. The UDM and/or UDR may send a notification to the PCF that was identified in the message at 5. The notification to the PCF may notify the PCF about the new QoS handling for the application instance by sending a policy update message. The UDM and/or UDR may update the PCF about the application instance's QoS parameters (e.g., QoS requirements). The message may include: the subscription identifier that is related to the application instance; the application instance identifier; the DNN and/or S-NSSAI combination of the PDU session; QoS settings for the application instance's traffic (e.g., QoS settings which may be based on the application's state), and/or flow descriptions for the application's traffic.

The flow descriptions may be IP 4 tuples. The UDM and/or UDR may have been provisioned with the flow description from the AF.

At 7, the PCF may perform a PCF initiated SM policy association modification based on the QoS parameters (e.g., QoS requirements) that were received in the message at 6. The result of this procedure may be that the QoS configuration of the PDU session is updated. A PDU session Modification command may be sent to the WTRU with QoS rules (e.g., new QoS rules) for the flows that carry the application's traffic. The SMF may update the N4 rules and/or QoS Profiles of the PDU session. The PDU session Modification command may include the application instance identifier. The PDU session modification message may include an application instance identifier and/or an indication that the SMF associated with the PDU session requests to be notified of changes of the state of the associated application. Inclusion of the application instance identifier in the PDU session modification message may be an implicit indication that the SMF associated with the PDU session and requests to be notified of changes of state of the associated application (e.g., application instance identifier). If the state of the application changes (e.g., again and/or later), the WTRU may send a NAS-SM notification message to the SMF to notify the SMF of the state change. The notification of state change may trigger another update of QoS configuration. The notification of state change may trigger another PDU session modification command.

At 8, the PCF may inform the UDM and/or UDR that the policy association is successful by sending an approval (e.g., OK) message.

At 9, the UDM may respond to the request sent by the SMF at 5, that the policy update is successful for the application ID.

At 10, the SMF may respond to the session update request sent by AMF at 4, by sending a session update response and/or indicating that the session has been updated successfully for the application instance identified by the application ID.

The AF initiated application specific QoS setting may be provided.

At 5 of the example procedure of FIG. 3, the UDM and/or UDR may be notified by the WTRU, via the SMF, about a change in the state of the application. The UDM may be (e.g., alternatively) notified by an AF. The UDM may receive the notification via an NEF. For example, the notification may come from an AF that is notified by the WTRU application if the WTRU state changes take place.

A WTRU initiated application specific QoS setting may be provided. In the example procedure of FIG. 3, the WTRU may send a notification to the AMF at 1. The AMF may interact with the UDM and/or UDR to obtain information that is used by the AMF to determine which SMF(s) serve the PDU session that carries the application's traffic. The AMF may provide the application information to each SMF that carries the application's traffic. The message at 1 (e.g., alternatively) may be a NAS-SM message that the WTRU may send (e.g., directly) to an SMF that carries the application's traffic. 2 and/or 3 may be skipped. The UDM and/or UDR may authorize usage of the application instance identifier at 6 based on the information that is received at 5.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1. A wireless transmit/receive unit (WTRU), comprising:
a processor configured to:
receive a first message, wherein the first message includes an application instance identifier and state information associated with an application;
send, to a first network node, a second message, wherein the second message includes the application instance identifier and the state information;
receive, from a second network node, a third message, wherein the third message includes the application instance identifier and a change of state request notification;
receive a change of state notification; and
send, to the second network node, a fourth message, wherein the fourth message notifies the second network node of a change of state of the application and includes traffic associated with the application.

2. The WTRU of claim 1, wherein the second message is a non-access stratum (NAS) mobility management (NAS-MM) or a NAS session management (NAS-SM) message.

3. The WTRU of claim 1, wherein the state information indicates whether the application is active or inactive.

4. The WTRU of claim 1, wherein the third message is a packet data unit (PDU) session modification message.

5. The WTRU of claim 1, wherein the third message indicates that the application instance identifier is authorized to be associated with the WTRU and further includes quality of service (QoS) rules for a flow associated with the traffic of the application.

6. The WTRU of claim 1, wherein the fourth message is a non-access stratum (NAS) session management (NAS-SM) message.

7. The WTRU of claim 1, wherein:
the change of state notification is received from a terminal equipment (TE) part of the WTRU, and
the first message is received from a hosted application in the TE part of the WTRU.

8. A method performed by a wireless transmit/receive unit (WTRU), the method comprising:
receiving, a first message, wherein the first message includes an application instance identifier and state information associated with an application;
sending, to a first network node, a second message, wherein the second message includes the application instance identifier and the state information;
receiving, from a second network node, a third message, wherein the third message includes the application instance identifier and a change of state request notification;
receiving a change of state notification; and
sending, to the second network node, a fourth message, wherein the fourth message notifies the second network node of a change of state of the application and includes traffic associated with the application.

9. The method of claim 8, wherein the second message is a non-access stratum (NAS) mobility management (NAS-MM) or a NAS session management (NAS-SM) message.

10. The method of claim 8, wherein the state information indicates whether the application is active or inactive.

11. The method of claim 8, wherein the third message is a packet data unit (PDU) session modification message.

12. The method of claim 8, wherein the third message indicates that the application instance identifier is authorized to be associated with the WTRU and further includes quality of service (QoS) rules for a flow associated with the traffic of the application.

13. The method of claim 8, wherein:
the WTRU is a mobile termination (MT) part of a wireless device,
the change of state notification is received from a terminal equipment (TE) part of the WTRU, and
the first message is received from a hosted application in the TE part of the WTRU.

14. A first network node, comprising:
a processor configured to:
receive a first message, wherein the first message includes an application instance identifier, an indication associated with a state of an application, and a notification that the application instance identifier is associated with a packet data unit (PDU) session;
send, to a second network node, a second message, wherein the second message includes a request to associate the application instance identifier with the PDU session and includes the indication associated with the state of the application;
receive, from a third network node, an indication of whether the application instance identifier is authorized to be associated with the PDU session;
receive, from the third network node, updated policy charging and control (PCC) rules, wherein the updated PCC rules are based on the application instance identifier;
send, to a wireless transmit/receive unit (WTRU), a third message, wherein the third message includes the application instance identifier and a change of state request notification; and
receive, from the WTRU, a fourth message, wherein the fourth message notifies the first network node of a change of state of the application and includes traffic associated with the application.

15. The first network node of claim 14, wherein the second message further includes an identity of the third network node that services the PDU session.

16. The first network node of claim 14, wherein the third message is a PDU session modification message.

17. The first network node of claim 14, wherein the third message indicates that the application instance identifier is authorized to be associated with the WTRU.

18. The first network node of claim 14, wherein the third message further includes quality of service (QoS) rules for a flow associated with the traffic of the application.

19. The first network node of claim 14, wherein the fourth message is a non-access stratum (NAS) session management (NAS-SM) message.

20. The first network node of claim 14, wherein the processor is further configured to:
update a quality of service (QoS) configuration of the PDU session based on the fourth message.
